(19) United States
(12) Patent Application Publication
(10) Pub. No.: US 2006/0274034 A1
(43) Pub. Date: Dec. 7, 2006

(54) Apparatus and method accommodating to operating system for processing screen data

(75) Inventors: Chien-Wu Yen, Chu-Nan (TW); Tzu-Hai Chung, Chu-Nan (TW)

Correspondence Address: BRUCE H. TROXELL;SUITE 1404, 5205 LEESBURG PIKE, FALLS CHURCH, VA, 22041, US

(73) Assignee: Coretronic Corporation

(21) Appl. No.: 11/445,329

(22) Filed: Jun. 2, 2006

(30) Foreign Application Priority Data
Jun. 3, 2005 (TW) 94118448

(51) Int. Cl. G09G 5/00

(52) U.S. Cl. 345/156

(57) ABSTRACT

An apparatus and a method accommodating to an operating system for processing screen data are provided. A virtual video memory is virtualized in a system memory of a computer. Next, in a kernel mode of the operating system, the screen data are written in a video memory of a graphic card of the computer and in the virtual video memory. Then, in the kernel mode, the screen data in the virtual video memory are compressed. And the compressed screen data are transmitted out through a short-distance wireless transmission module of the computer to an outer display device.

### BACKGROUND OF THE INVENTION

(1) Field of the Invention

The present invention generally relates to an apparatus and a method for processing screen data, and particularly to an apparatus and a method accommodating to an operating system for caching, compressing and wirelessly transmitting screen data.

(2) Description of the Prior Art

A wireless display device, such as a wireless projector, has become an important trend of technology development in multimedia output device. Getting rid of messy wires, the wireless display device is more suitable for all kinds of environments.

Take the wireless projector for example. Screen data of a computer are wirelessly transmitted out through a short-distance wireless transmission module in the computer. Then, another short-distance wireless transmission module in the wireless projector receives the screen data, so that the wireless projector can project a corresponding image subsequently. The above-described short-distance wireless transmission module can be an infrared communication port, an IEEE 802.11a/b/g communication port, and a bluetooth communication port, etc.

However, due to a processing limitation of a hardware in the computer and a bandwidth limitation of the wireless network, there is considerably huge difficulty in the transmission of the screen data. At present, the hardware can not be improved yet. Therefore, a solution focuses on the improvement in the transmission of the screen data. The solution is compressing the screen data in the computer first and then transmitting the compressed screen data to the wireless projector.

When the screen data are compressed by a software, full-color XGA animated screen data can not be transmitted smoothly to the wireless projector even using a best computer and network apparatus in the present time. When compressed by hardware, the screen data can be compressed better. However, the cost is increased correspondingly.

Most of the prior arts focus on the improvement of the compressing algorithm to increase the compressing ratio of the screen data. The present invention is different from this point of view to seek another solution. Please refer to FIG. 1. A conventional operating system 2 is installed in a computer 4. The operating system 2 includes a user mode 202 and a kernel mode 204.

In the user mode 202, the operating system 2 provides a user with an environment to process data directly. In the kernel mode 204, the operating system 2 provides the user with an environment where the user can define the driver program and the brand of hardware, set the memory address, or confirm the requirements of the subprogram, such as a peek function/processing program. The difference between the user mode 202 and the kernel mode 204 is that the user mode 202 prevents the user from changing unchangeable data when the user processes data. Through system call, the environment of the operating system 2 can be switched between the user mode 202 and the kernel mode 204.

In the computer 4, the screen data are processed by a graphic card 8 are cached in a video memory 22 of the graphic card 8 in the kernel mode 204 of the operating system 2. The screen data are cached through the graphic card 8, such as a VGA card, cooperating with a chip set, a processor, etc. (not shown in FIG. 1). At the same time, the screen data cached in the video memory 22 of the graphic card 8 are provided for a displayer 14 of the computer 4 to display a corresponding image subsequently. When the screen data in the computer 4 are transmitted to a wireless projector 12 through short-distance wireless transmission, a short-distance wireless transmission module 10a in the computer 4 cooperating with a timer 6 sends a wireless application periodically accommodating to the operating system 2 in the user mode 202. Subsequently, through the system call, the user mode 202 is switched to the kernel mode 204 in the operating system 2 of the computer 4, for commanding the screen data cached in a video memory 22 of the graphic card 8 to be copied and cached in a kernel buffer 24.

However, the compression and transmission are both processed in the user mode 202. Therefore, the operating system 2 is switched to the user mode 202 from the kernel mode 204 through the system call, so that the screen data cached in the kernel buffer 24 can be copied and cached in a user buffer 26.

Next, the screen data in the user buffer 26 are compressed. Through a short-distance wireless transmission module 10a in the computer 4, the compressed screen data are transmitted to a short-distance wireless transmission module 10b in the wireless projector 12. And the screen data are for the wireless projector 12 to display an image.

The condition to display a fluent animated image for visual observation is that there has to be about 30 images per second. However, in the process of each image, the environment of the operating system 2 needs to be switched between the user mode 202 and kernel mode 204 twice, which means the animated screen data are read repeatedly (polling)2*30=60 times per second. As a result, the process is considerably inefficiently.

Therefore, the objective of the present invention is to provide an apparatus and a method accommodating to an operating system for caching, compressing and wirelessly transmitting screen data. The apparatus and the method of the present invention are different from those of the prior art focusing on the improvement the compressing algorithm. The apparatus and the method of the present invention utilize a easier way to solve the above-described problem.

### SUMMARY OF THE INVENTION

An objective of the present invention is to provide an apparatus and a method accommodating to an operating system for caching, compressing and wirelessly transmitting screen data. The apparatus and method of the present invention are different from the prior arts which are improving a compressing algorithm. The apparatus and method of the present invention improve the process of caching, compressing and wirelessly transmitting the screen data. As a result, it is more efficient to transmit the screen data, and an image quality is improved.

The present invention relates to an apparatus and a method accommodating to an operating system for processing screen data. The operating system (OS) is installed in a computer. And the apparatus is disposed in the computer as well. The operating system includes a user mode and a kernel mode.

The apparatus and method are as follow. First, a virtual video memory is virtualized in a system memory of the computer. Next, screen data are written in a video memory of a graphic card of the computer in the kernel mode. The screen data are also written in the virtual video memory in the kernel mode. The screen data written in the video memory of the graphic card in the kernel mode are displayed in a displayer of the computer subsequently.

Then, the screen data in the virtual video memory are compressed in the kernel mode. And, the compressed screen data are transmitted to an outer display device through a short-distance wireless transmission module in the kernel mode.

The display device can be a wireless projector. The wireless projector includes a short-distance wireless transmission module to receive the compressed screen data from the short-distance wireless transmission module in the computer.

Moreover, the above apparatus and method further include the following steps. A wireless application is generated in the user mode. The wireless application is used to execute a system call for switching the user mode to the kernel mode. The screen data in the virtual video memory is commanded to be compressed in the kernel mode. Therefore, the user mode is only switched to the kernel mode once when the wireless application transmits enable parameters. After that, there is no switching process.

Therefore, the method of the present invention accommodating to an operating system for processing screen data is different from that of the prior art which focuses on improving the compressing algorithm. The method of the present invention utilizes the environment of the kernel mode to cache, compress and wirelessly transmit the screen data. It is more efficient to wirelessly transmit the screen data to the wireless projector from the computer. And the image quality is improved.

These and other objectives of the present invention will no doubt become obvious to those of ordinary skill in the art after reading the following detailed description of the preferred embodiment which is illustrated in the various figures and drawings.

### BRIEF DESCRIPTION OF THE DRAWINGS

The present invention will now be specified with reference to its preferred embodiment illustrated in the drawings, in which

FIG. 1 illustrates a conventional operating system caching, compressing and wirelessly transmitting the screen data;

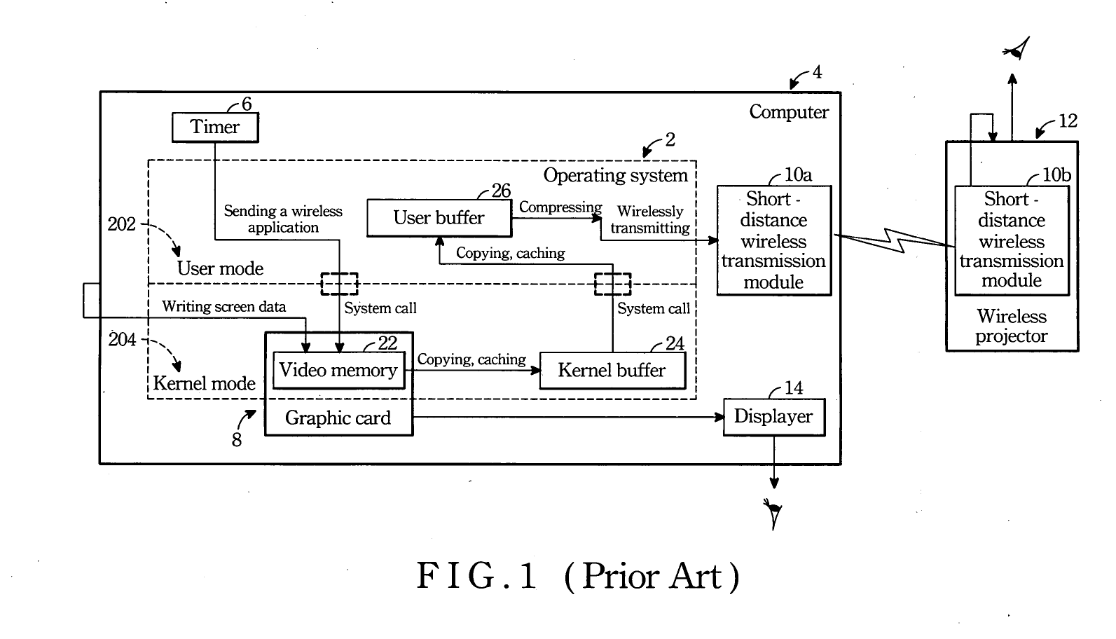

FIG. 2 illustrates an apparatus in a computer according to the present invention;

FIG. 3 illustrates the apparatus of the present invention; and

FIG. 4 illustrates a flow chart according to a method of the present invention.

### DESCRIPTION OF THE PREFERRED EMBODIMENT

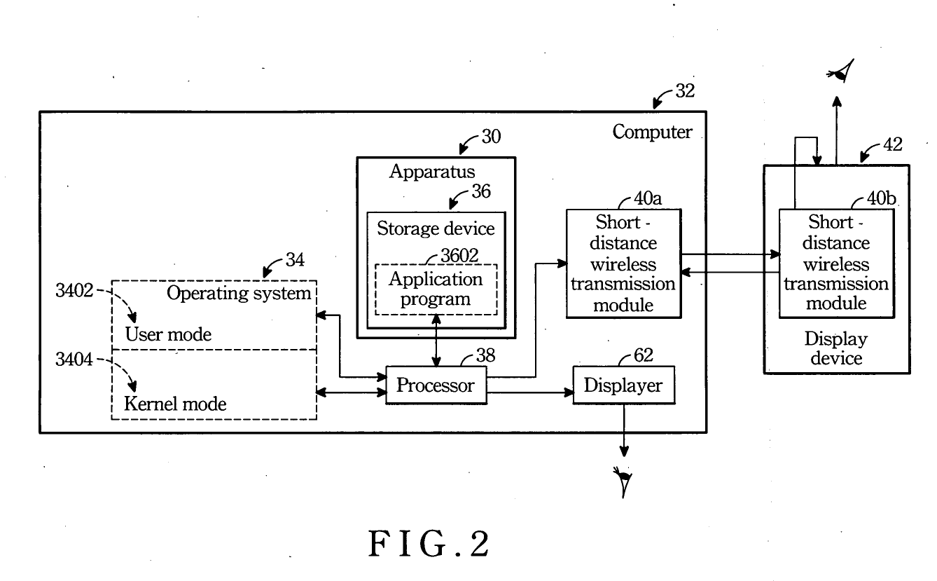

Please refer to FIG. 2. The present invention relates to an apparatus 30 accommodating to an operating system 34 for processing screen data. The apparatus 30, the operating system 34, a processor 38, a short-distance wireless transmission module 40a, and a displayer 64 are disposed in a computer 32.

The operating system 34 includes a user mode 3402 and a kernel mode 3404. The apparatus 30 includes a storage device 36 and an application program 3602 stored in the storage device 36. The application program 3602 accommodating to the process 38 of the computer 32 to process the screen data.

The apparatus 30 controls the screen data through the processor 38. In the beginning, enable parameters of an wireless application are transmitted in the user mode 3402 to the kernel mode 3404 through a system call. Then, the screen data needed to be transmitted are cached, compressed and wirelessly transmitted accommodating to the kernel mode 3404 of the operating system 34. Therefore, it is faster and more efficient to transmit the screen data from the short-distance wireless transmission module 40a of the computer 32 to an outer apparatus, such as a short-distance wireless transmission module 40b of a display device 42 in a wireless projector.

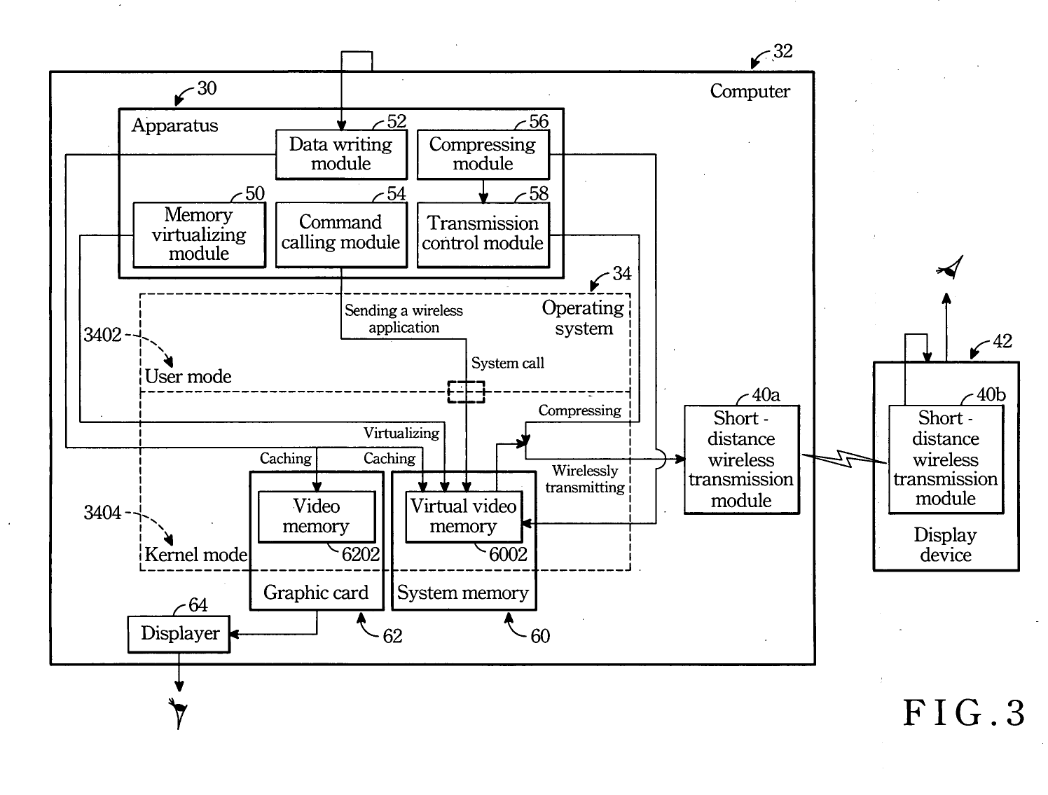

Please further refer to FIG. 2 and FIG. 3. The apparatus 30 of the present invention includes a memory virtualizing module 50, a data writing module 52, a compressing module 56, a transmission control module 58 and a command calling module 54.

The computer 32 further includes a system memory 60 and a graphic card 62. A video memory 6202 is disposed in the graphic card 62 and a virtual video memory 6002 is disposed in the system memory 60. First, the memory virtualizing module 50 virtualizes the virtual video memory 6002 in the system memory 60 of the computer 32.

In the kernel mode 3404, the data writing module 52 writes the screen data in the video memory 6202 in the graphic card 62 of the computer 32. The data writing module 52 also writes the screen data in the virtual video memory 6002 in the kernel mode 3404. The screen data written in the video memory 6202 of the graphic card 62 in the kernel mode 3404 are displayed in the displayer 64 of the computer 32 subsequently.

In the kernel mode 3404, the compressing module 56 is used for compressing the screen data cached in the virtual video memory 6002.

In the kernel mode 3404, the transmission control module 58 is used for transmitting the compressed screen data through the short-distance wireless transmission module 40a of the computer 32 to an outer apparatus, such as the displayer 42 of the wireless projector. The displayer 42 includes a short-distance wireless transmission module 40b to receive the compressed screen data from the short-distance wireless transmission module 40a in the computer 32.

The command calling module 54 executes the system call according to the wireless application generated in the user mode 3402, for switching the user mode 3402 to the kernel mode 3404. The enable parameters relative to the wireless application are also transmitted to the kernel mode 3404, for commanding the screen data in the virtual video memory 6002 to be compressed and wirelessly transmitted in the kernel mode 3404 subsequently.

Therefore, the user mode 3402 is switched to the kernel mode 3404 through the system call only once in the beginning when the wireless application transmits the enable parameters. After that, there is no more switching process.

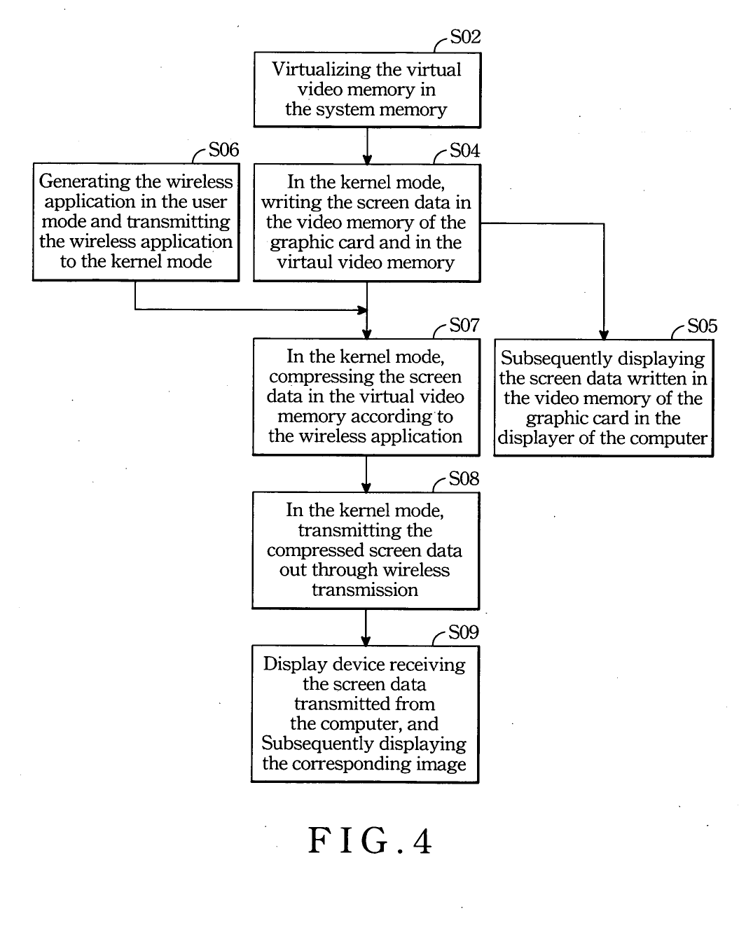

Please refer to FIG. 4. A method of the present invention is the method of the above apparatus 30 accommodating to the operating system 34 for processing the screen data. The method includes the following steps.

Step S02: the virtual video memory 6002 is virtualized in the system memory 60 of the computer 32.

Step S04: in the kernel mode 3404, the screen data are written in the video memory 6202 of the graphic card 62 in the computer 32. The screen data are also written in the virtual video memory 6002 in the kernel mode 3404.

Step S05: the screen data written in the video memory 6202 of the graphic card 62 in the kernel mode 3404 are displayed in the displayer 64 of the computer 32 subsequently.

Step S06: moreover, a wireless application is generated in the user mode 3402. The wireless application is used to execute the system call for switching the operating system 34 to the kernel mode 3404 from the user mode 3402. The enable parameters relative to the wireless application are transmitted to the kernel mode 3404.

Step S07: in the kernel mode 3404, the screen data in the virtual video memory 6002 are compressed according to the wireless application.

Step S08: in the kernel mode 3404, the compressed screen data are transmitted out though the short-distance wireless transmission module 40a of the computer 32.

Step S09: then, a short-distance wireless transmission module 40b of the display device 42, such as a wireless projector, receives the compressed screen data from the short-distance wireless transmission module 40a of the computer 32. Subsequently, the screen data are decompressed to display an image on a screen in a distance according to the screen data.

Therefore, the method of the present invention accommodating to the operating system 34 for processing the screen data is different from that of the prior art which focuses on improving the compressing algorithm. The method of the present invention utilizes the environment of the kernel mode 3404 of the computer 34 to cache, compress and wirelessly transmit the screen data. Therefore, it is more efficient to transmit screen data from the computer 32 to the wireless projector. And the image quality is improved.

With the example and explanations above, the features and spirits of the invention are hopefully well described. Those skilled in the art will readily observe that numerous modifications and alterations of the device may be made while retaining the teaching of the invention. Accordingly, the above disclosure should be construed as limited only by the metes and bounds of the appended claims.

We claim:

1. A method accommodating to an operating system for processing screen data, the operating system (OS) installed in a computer, the operating system comprising a user mode and a kernel mode, the method comprising:
virtualizing a virtual video memory in a system memory of the computer;
in the kernel mode, writing the screen data in a video memory of a graphic card of the computer and writing the screen data in the virtual video memory;
in the kernel mode, compressing the screen data in the virtual video memory; and
in the kernel mode, transmitting the compressed screen data to a display device through a short-distance wireless transmission module of the computer.

2. The method of claim 1, wherein the display device is a wireless projector, the wireless projector comprising a short-distance wireless transmission module to receive the compressed screen data from the short-distance wireless transmission module of the computer.

3. The method of claim 1 further comprising:
generating a wireless application in the user mode, executing a system call through the wireless application to switch the user mode to the kernel mode, for commanding the screen data in the virtual video memory to be compressed in the kernel mode subsequently.

4. The method of claim 1, wherein the screen data written in the video memory of the graphic card in the kernel mode are displayed in a displayer of the computer subsequently.

5. The method of claim 1, wherein the computer further comprises a storage device and an application program stored in the storage device, the application program accommodating to a processor of the computer to process the screen data.

6. An apparatus accommodating to an operating system for processing screen data, the apparatus disposed in a computer, and the operating system installed in the computer, the operating system comprising a user mode and a kernel mode, the apparatus comprising:
a memory virtualizing module virtualizing a virtual video memory in a system memory of the computer;
a data writing module writing the screen data in a video memory of a graphic card of the computer in the kernel mode, and writing the screen data in the virtual video memory in the kernel mode;
a compressing module compressing the screen data in the virtual video memory in the kernel mode; and
a transmission control module transmitting the compressed screen data to a display device through a short-distance wireless transmission module of the computer in the kernel mode.

7. The apparatus of claim 6, wherein the display device is a wireless projector, the wireless projector comprising a short-distance wireless transmission module to receive the compressed screen data transmitted from the short-distance wireless transmission module of the computer.

8. The apparatus of claim 6 further comprising:
a command calling module executing a system call according to a wireless application generated in the user mode to switch the user mode to the kernel mode, for subsequently commanding the screen data in the virtual video module to be compressed in the kernel mode.

9. The apparatus of claim 6, wherein the screen data written in the video memory of the graphic card in the kernel mode are displayed in a displayer of the computer subsequently.

10. The apparatus of claim 6 further comprising a storage device and an application program stored in the storage device, wherein the application program processes the screen data accommodating to a processor of the computer.
